(19) United States
(12) Patent Application Publication
(10) Pub. No.: US 2026/0282125 A1
(43) Pub. Date: Sep. 17, 2026

(54) METHOD AND APPARATUS FOR SEAMLESS DYNAMIC CONFIGURATION FOR SPLIT INFERENCING IN A MOBILE COMMUNICATION SYSTEM

(71) Applicant: Samsung Electronics Co., Ltd., Suwon-si, Gyeonggi-do (KR)

(72) Inventor: Eric YIP, Suwon-si (KR)

(21) Appl. No.: 19/168,461

(22) PCT Filed: Mar. 28, 2024
(86) PCT No.: PCT/KR2024/003935

§ 371 Date: Sep. 24, 2025

(30) Foreign Application Priority Data
Apr. 5, 2023 (KR) 10-2023-0044643

(51) Int. Cl. H04W 76/12; H04L 41/16; H04W 8/22

(52) U.S. Cl. CPC H04W 76/12; H04L 41/16; H04W 8/22

(57) ABSTRACT

The disclosure relates to a 5G or 6G communication system for supporting a higher data transmission rate. The present disclosure provides method and apparatus for seamless dynamic configuration of for split inferencing in a mobile communication system.

### TECHNICAL FIELD

The present disclosure relates a mobile communication system (or, a wireless communication system). The disclosure relates to 5G network systems for multimedia, architectures and procedures for AI(artificial intelligence)/ML(machine learning) model transfer and delivery over 5G, AI/ML model transfer and delivery over 5G for AI enhanced multimedia services.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mm Wave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE OF INVENTION

### Technical Problem

Current implementations of AI/ML are mainly proprietary solutions, enabled via applications without compatibility with other market solutions. In order to support AI/ ML for multimedia applications over 5G, AI/ML models should support compatibility between UE devices and application providers from different MNOs (mobile network operators). Not only this, but AI/ML model delivery for AI/ML media services should support media context, UE status, and network status-based selection and delivery of the AI/ML model. The processing power of UE devices is also a limitation for AI/ML media services, since next generation media services, such as AR, are typically consumed on lightweight, low processing power devices, such as AR glasses, for which long battery life is also a major design hurdle/limitation.

Due to such limitations, AI inferencing for such media applications will commonly leverage network resources such as the cloud or edge, for split inferencing between the network and UE device, where a part of the AI model is inferenced in the network, and the rest of the AI model is inference on the UE device (the reverse is also possible).

Nevertheless, for such scenarios where inferencing (whether full or split) needs to take place on the UE device, either the full or partial split AI model must be delivered to the UE from the network.

A summary of the problem statements includes at least one of:
AI inferencing for media processing is computationally heavy, requiring leverage of network resources.
AI model needs to be delivered from network to UE as user plane data.
Split AI inferencing between UE and network requires dynamic configurations during the service.
Changing split points during the service requires re-configuration, and delivery of a different split AI model for the UE is also needed.

### Solution to Problem

The disclosure describes mechanisms to deliver an AI model to the UE device for split inferencing where:
The whole model may be delivered in subsets to the UE at the first configuration,
AI model subsets are independently inferenceable,
Subsets may be created by the service provider:
   Arbitrarily; and/or
   According to the split points defined for the service such that no further user plane AI model data delivery is necessary on dynamic configurations.

Corresponding procedures to enable subset based split AI/ML model delivery and configurations and corresponding metadata related to the split points and subsets, to enable proper inferencing of the subsets on the UE are also specified.

According to various embodiments of the disclosure, a method performed by a user equipment (UE) in a wireless communication system, the method comprising: obtaining, from a 5G artificial intelligence (AI) application provider, service access information by a 5G AI aware application in the UE; transmitting, to a 5G AI application function (AF) entity discovered based on an AI media capability, a request for an AI split inferencing, by an AI data session handler in the UE; receiving, form the 5G AI AF entity, information on the AI split inferencing by the AI data session handler in the UE; transmitting, to 5G AI application server (AS) entity, a request for starting AI data delivery based on the AI split inferencing; and processing the AI split inferencing for data received via a data delivery pipeline between the 5G AI client in the UE and the 5G AI AS entity.

According to various embodiments of the disclosure, a user equipment (UE) is provided. The UE comprises a transceiver; and a controller coupled with the transceiver and configured to: obtain, from a 5G artificial intelligence (5GAI) application provider, service access information by a 5G AI aware application in the UE, transmit, to a 5G AI application function (AF) entity discovered based on an AI media capability, a request for an AI split inferencing, by an AI data session handler in the UE, receive, form the 5G AI AF entity, information on the AI split inferencing by the AI data session handler in the UE, transmit, to 5G AI application server (AS) entity, a request for starting AI data delivery based on the AI split inferencing, and process the AI split inferencing for data received via a data delivery pipeline between the 5G AI client in the UE and the 5G AI AS entity.

### Advantageous Effects of Invention

According to the various embodiments of the disclosure, the following can be achieved efficiently: network status, UE status and multimedia context driven AI/ML model selection, delivery and management between network and UE for multimedia services.

### BRIEF DESCRIPTION OF DRAWINGS

FIG. 1 illustrates an overall 5G media streaming architecture, in accordance with an embodiment of the disclosure.

FIG. 2 illustrates a 5G media streaming general architecture, in accordance with an embodiment of the disclosure.

FIG. 3 illustrates a high-level procedure for media downlink streaming in accordance with an embodiment of the disclosure.

FIG. 4 illustrates a baseline procedure describing the establishment of a unicast media downlink streaming session in accordance with an embodiment of the disclosure.

FIG. 5 illustrates a simple AI/ML media service scenario where an AI/ML model is required to be delivered from network to end device (i.e., user equipment (UE)), in accordance with an embodiment of the disclosure.

FIG. 6 illustrates a scenario where an AI model is delivered to end device and a media is also streamed to the end device, in accordance with an embodiment of the disclosure.

FIG. 7 illustrates a scenario where inferencing required for AI media service is split between network and UE.

FIG. 8 illustrates AI for media (AI4Media) architecture) which identifies various functional entities and interfaces for enabling AI model delivery in accordance with an embodiment of the disclosure.

FIG. 9 illustrates a case where separate partial AI models or files are created and delivered from network to UE, in accordance with an embodiment of the disclosure.

FIG. 10 illustrates a case where arbitrary subsets are created in the network of whole AI model, in accordance with an embodiment of the disclosure.

FIG. 11 illustrates a case where separate partial AI models, files are created according to split points previously defined for the service, in accordance with an embodiment of the disclosure.

FIG. 12 illustrates an embodiment of the disclosure showing a procedure for the delivery of AI model with configurations between network and UE, in accordance with an embodiment of the disclosure.

FIG. 13 illustrates an extension of the procedures for the delivery of AI model with configurations between network and UE, in particular update of split configuration and model delivery pipelines, in accordance with an embodiment of the disclosure.

FIG. 14 illustrates an exemplary structure of a UE in accordance with an embodiment of the disclosure.

FIG. 15 illustrates an exemplary structure of a base station in accordance with an embodiment of the disclosure.

FIG. 16 illustrates an exemplary structure of a network entity in accordance with an embodiment of the disclosure.

### MODE FOR THE INVENTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is known to those skilled in the art that blocks of a flowchart (or sequence diagram) and a combination of flowcharts may be represented and executed by computer program instructions. These computer program instructions may be loaded on a processor of a general purpose computer, special purpose computer, or programmable data processing equipment. When the loaded program instructions are executed by the processor, they create a means for carrying out functions described in the flowchart. Because the computer program instructions may be stored in a computer readable memory that is usable in a specialized computer or a programmable data processing equipment, it is also possible to create articles of manufacture that carry out functions described in the flowchart. Because the computer program instructions may be loaded on a computer or a programmable data processing equipment, when executed as processes, they may carry out operations of functions described in the flowchart.

A block of a flowchart may correspond to a module, a segment, or a code containing one or more executable instructions implementing one or more logical functions, or may correspond to a part thereof. In some cases, functions described by blocks may be executed in an order different from the listed order. For example, two blocks listed in sequence may be executed at the same time or executed in reverse order.

In this description, the words “unit”, “module” or the like may refer to a software component or hardware component, such as, for example, a field-programmable gate array (FPGA) or an application-specific integrated circuit (ASIC) capable of carrying out a function or an operation. However, a “unit”, or the like, is not limited to hardware or software. A unit, or the like, may be configured so as to reside in an addressable storage medium or to drive one or more processors. Units, or the like, may refer to software components, object-oriented software components, class components, task components, processes, functions, attributes, procedures, subroutines, program code segments, drivers, firmware, microcode, circuits, data, databases, data structures, tables, arrays or variables. A function provided by a component and unit may be a combination of smaller components and units, and may be combined with others to compose larger components and units. Components and units may be configured to drive a device or one or more processors in a secure multimedia card.

Prior to the detailed description, terms or definitions necessary to understand the disclosure are described. However, these terms should be construed in a non-limiting way.

The “base station (BS)” is an entity communicating with a user equipment (UE) and may be referred to as BS, base transceiver station (BTS), node B (NB), evolved NB (eNB), access point (AP), 5G NB (5GNB), or gNB.

The “UE” is an entity communicating with a BS and may be referred to as UE, device, mobile station (MS), mobile equipment (ME), or terminal.

The “network entity” may be referred to as function, network function, core network function, core network entity, or server.

Artificial Intelligence (AI) is a general concept defining the capability for a system to act based on 2 major conditions below:
The context in which a task has to be done, meaning the value or state of different input parameters.
The past experience of achieving the same task with different parameter values and the record of potential success with each parameter value.

Machine Learning (ML) is often described as a subset of AI, in which an application has the capacity to learn from the past experience. This learning feature usually starts with an initial training phase so as to ensure a minimum level of performance when it is placed into service.

Recently, AI/ML has been introduced and generalized in media related applications, ranging from legacy applications such as image classification, speech/face recognition, to more recent ones such as video quality enhancement. As research into this field matures, more and more complex AI/ML-based applications requiring higher computational processing can be expected; such processing involves dealing with significant amounts of data not only for the inputs and outputs into the AI/ML models, but also for the increasing data size and complexity of the AI/ML models themselves. This growing amount of AI/ML related data, together with a need for supporting processing intensive mobile applications (such as VR, AR/MR, gaming, and more), highlights the importance of handling certain aspects of AI/ML processing by the server over 5G system, in order to meet the required latency requirements of various applications.

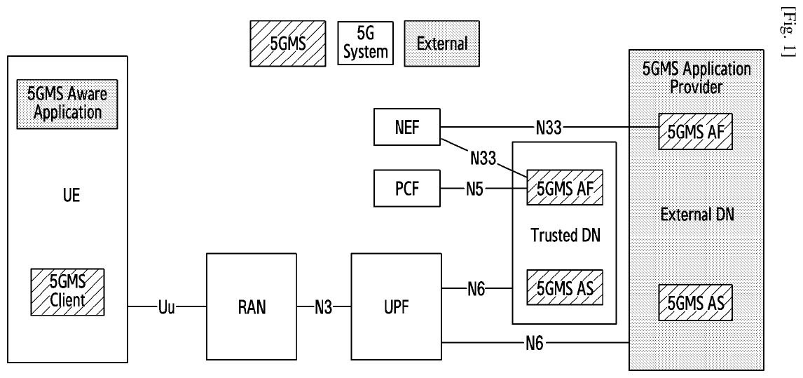

FIG. 1 shows the overall 5G Media Streaming Architecture in TS 26.501, representing the specified 5GMS (5G media streaming) functions within the 5GS (5G system) as defined TS 23.501.

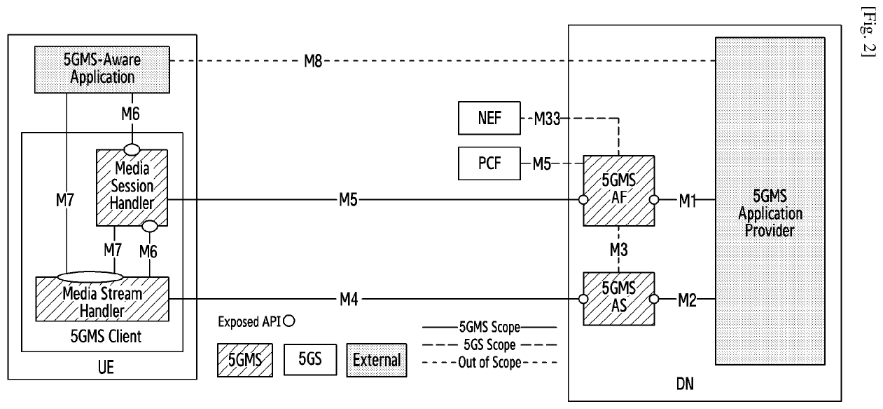

FIG. 2 shows the 5G Media Streaming General Architecture from TS 26.501. The FIG. 2 shows media streaming functional entities and interfaces which are specified within the specification.

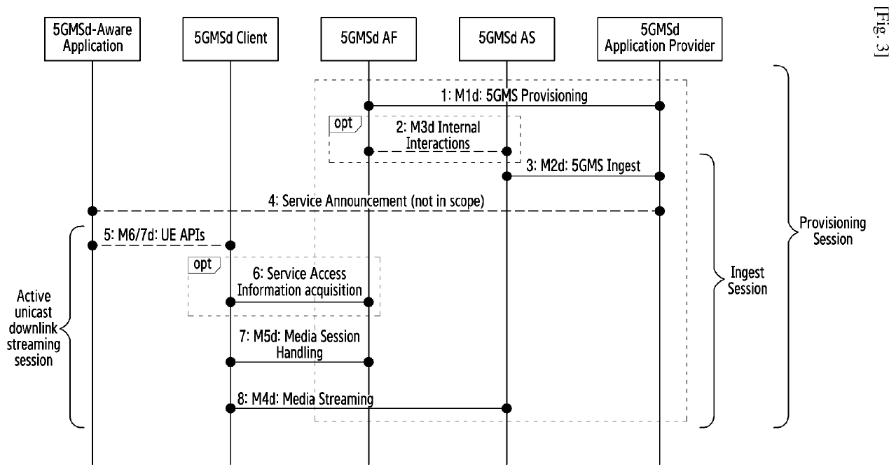

FIG. 3 shows the high-level procedure for media downlink streaming as specified in TS 26.501.

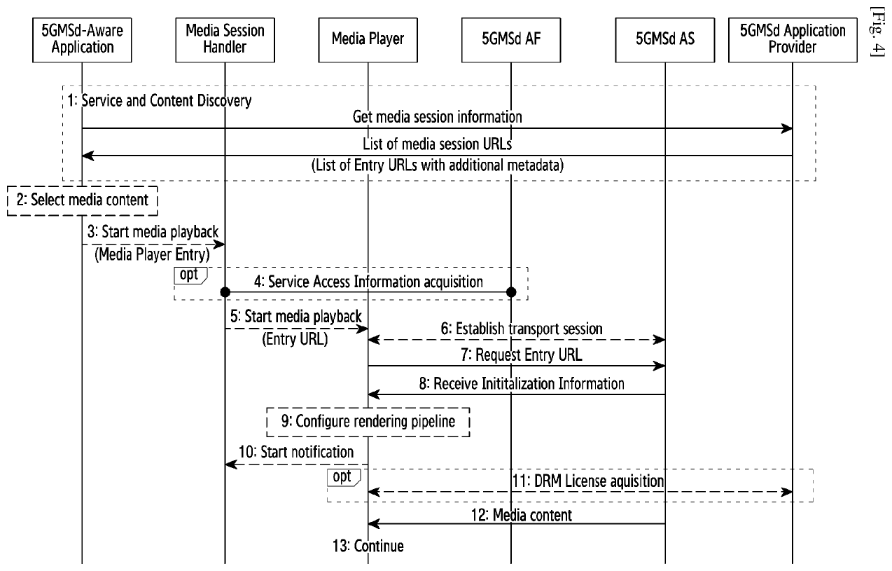

FIG. 4 shows, for reference, the baseline procedure describing the establishment of a unicast media downlink streaming session as defined by TS 26.501.

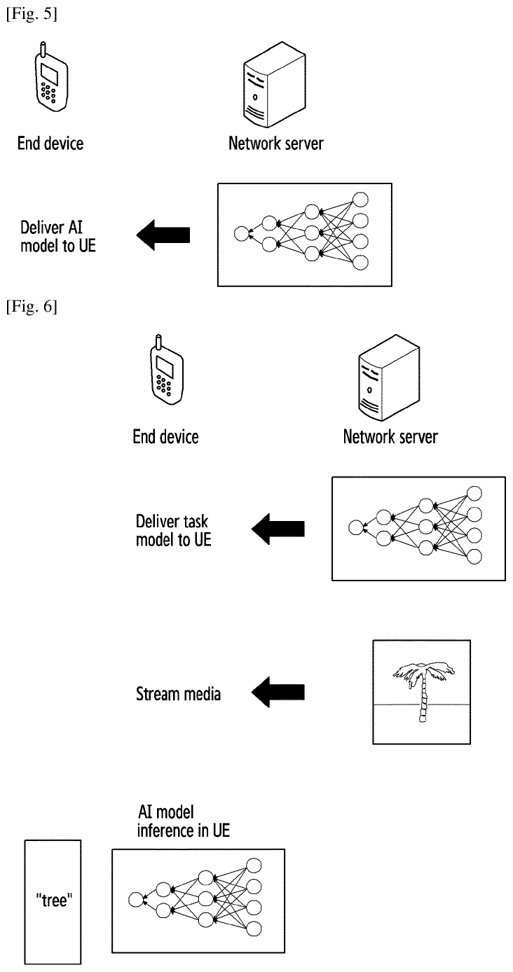

FIG. 5 shows a simple AI/ML media service scenario where an AI/ML model is required to be delivered from the network to the UE (end device). Upon receiving the AI model, the UE device performs the inferencing of the model, feeding the relevant media as an input into the AI model.

An example for the scenario of FIG. 5 is as follows:
John is in Seoul for his summer vacation, and he is in Jamsil wanting to visit Lotte Tower for sightseeing. John cannot read Korean, and finds it difficult to navigate his way to Lotte Tower.
John takes out his mobile phone (i.e., UE), and opens an augmented reality navigation service on it. His network operator provides the service via 5G, and through the analysis of different information, a suitable AI model is delivered to his mobile phone. Such information includes information available from the network, such as John's UE's location, his charging policy, network availability and conditions (bandwidth, latency) etc., his UE's processing capabilities and status, as well as the media properties which will be used as the input to the AI model.
Once the AI model is delivered to John's phone, the AR navigation service initiates the camera on the phone to capture the John's surroundings.
The captured video from the phone's camera is fed as the input into the AI model, and the AI model inferencing is initiated.
The output of the AI model provides direction labels (such as navigation arrows) which are shown as overlays in the phone's screen live camera in order to guide John to Lotte Tower. Road signs in Korean are also overlayed by English labels output from the AI model.

FIG. 6 shows a scenario where an AI model is delivered to the UE, and also where media (such as video) is also streamed to the UE. In the UE, the streamed video is fed as an input into the received AI model for processing.

The AI model may perform any media related processing, for example: video upscaling, video quality enhancement, vision applications such as object recognition, facial recognition, etc.

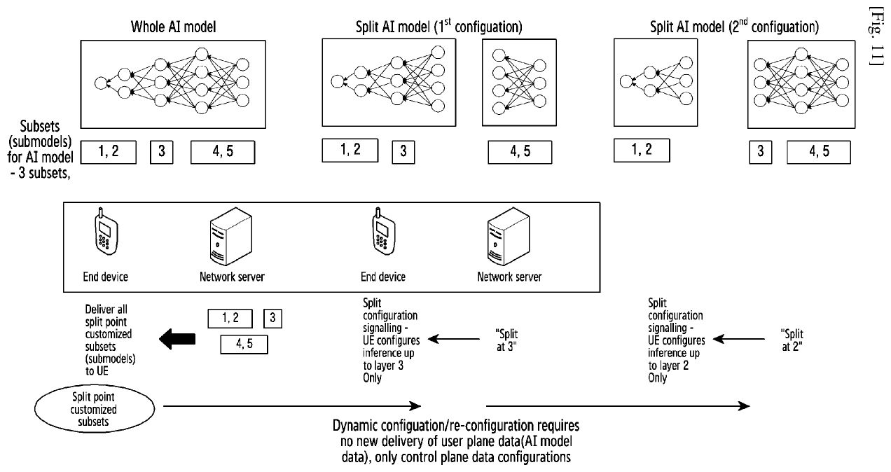

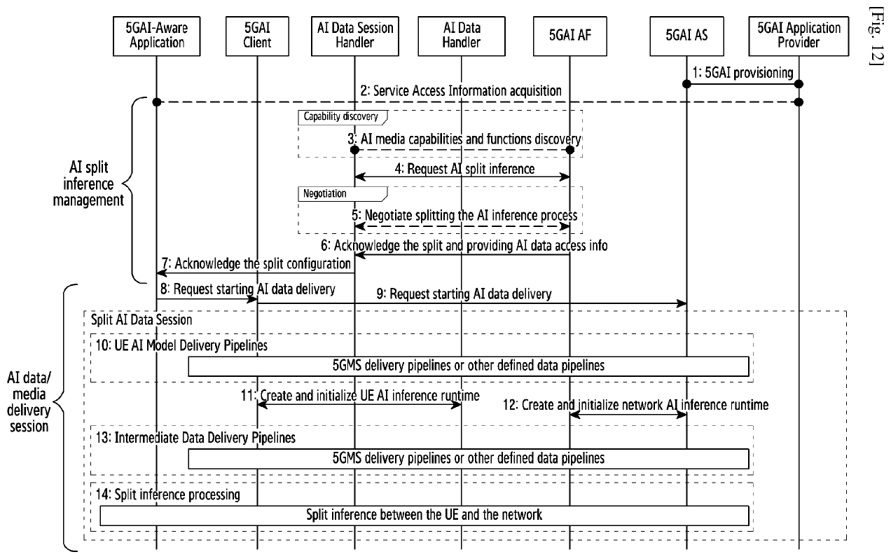

A simple description of the required steps is as follows. The detail procedure will be described in FIGS. 12 and 13:
Service announcement
Request/selection by UE or network (which task UE wants to perform, takes into account media requirements, network status parameters, UE status parameters, network or UE selects suitable AI model)
Provision & ingest model in network
Provision media in network
Session(s) establishment(s)
Delivery AI model from network to UE
Configure media session downlink
Stream media from network
AI media inference in UE

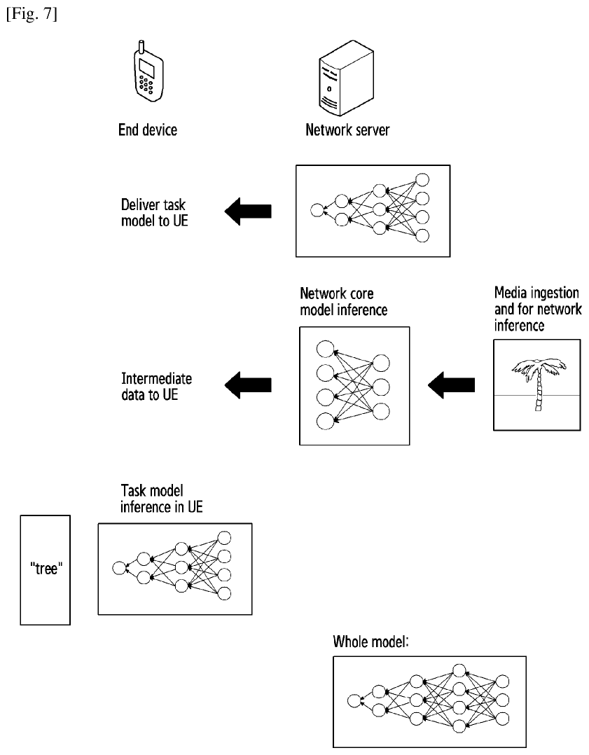

FIG. 7 shows a scenario where the inferencing required for the AI media service is split between the network and UE. A portion of the AI model to be inferenced on the UE is delivered from network to the UE. Another portion of the AI model to be inferenced in the network is provisioned by the network to an entity which performs the inferencing in the network. The media for inferencing is firstly provisioned and ingested by the network to the network inferencing entity, when feeds the media as an input into the network portion of the AI model. The output of the network side inference (intermediate data) is then sent to the UE, which received this intermediate data and feeds it as an input into the UE side portion of the AI model, hence completing the inference of the whole model.

In this scenario, the split decision and configuration is negotiated between the UE and the network, and a simple description of the required steps is as follows. The detail procedure will be described in FIG. 12:
Service announcement
Request/selection by UE (which task it wants to perform, gives media requirements, AF selects suitable model head)
Provision UE task model head and core model in network
Provision media in network
Split configuration setup & establishment
Session(s) establishment(s)
   Configure intermediate data session downlink
Download/stream model head from network
Perform network core model inference
Stream intermediate data from network
Task model inference in UE

In one split configuration example, an AI model service may consist of a core portion, as well as a task specific portion (e.g. traffic sign recognition task, or facial recognition task), where the core portion of the AI model is common to multiple possible tasks. In this case, the split configuration may coincide the core and task portions in a manner such that the network performs the inference of the core portion of the model, and the UE (receives and) performs the inference of the task portion of the model.

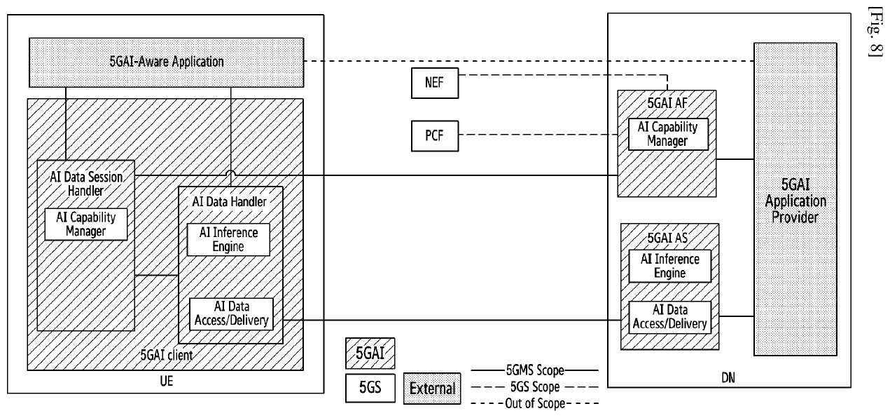

FIG. 8 shows an AI for media (AI4Media) architecture which identifies various functional entities and interfaces for enabling AI model delivery for media services in this invention. Network functions or network entities of the FIG. 8 are described as below.

5GAI AF: An Application Function similar to that defined in TS 23.501 clause 6.2.10, however 5GAI AF is dedicated to AI media services. 5GAI AF typically provides various control functions to the AI Data Session Handler on the UE and/or to the 5GAI Application Provider. 5GAI AF may interact with other 5GC network functions, such as a Data Collection Proxy (DCP) function entity (which interacts with the AI/ML Endpoint and/or 3GPP Core Network to collect information required for the 5GAI AF). The DCP may or may not include NWDAF (network data analytic function) function/functionality. The 5GAI AF may contain logical subfunctions such as an AI Capability Manager, which handles the negotiation and handling of capability related data and decision in the network, and also between the network and UE.

5GAI AS: An Application Server dedicated to AI media services, which hosts 5G AI media (sub)functions, such as the AI Data Delivery/access function and AI Inference Engine. The 5GAI AS typically supports AI model hosting by ingesting AI models from an AI Media Application Provider, and egesting (or, providing) models to other network functions for network inferencing, such as the Media AS. In addition to those described above, the 5GAI AS may also contain Media AS functionalities. The 5GAI AS may also contain an AI Inference Engine subfunction which performs full or partial inferencing on the network.

5GAI Media Application Provider: External application, with content-specific media functionality, and/or AI-specific media functionality (AI model creation, splitting, updating etc.).

The 5GAI Client in the UE contains:
AI Data Session Handler: A function on the UE that communications with the 5GAI AF in order to establish, control and support the delivery of an AI model session, and/ or a media session, and may perform additional functions such as consumption and QoE metrics collection and reporting. The AI Data Session Handler may expose APIs that can be used by the 5GAI Aware Application. It may contain logical subfunctions such as an AI Capability Manager, which handles the negotiation and handling of capability related data and decision internally in the UE, and also between the UE and network.
AI Data Handler: A function on the UE that communicates with the AI AS in order to download/stream (or even upload) the AI model data, and may provide APIs to the 5GAI Aware Application for AI model inferencing, and to the AI Data Session Handler for AI model session control in the UE, and also the subfunctions AI Data Access Function for accessing AI model data such as topology data and or AI model parameters (weights, biases), and AI Inference Engine for inferencing in the UE.

In another embodiment of this invention, the AI inference engine in the UE may exist outside the AI Data Handler. It may also exist in another function in the UE.

In another embodiment of this invention, the AI engine in the network may exist outside the 5GAI AS.

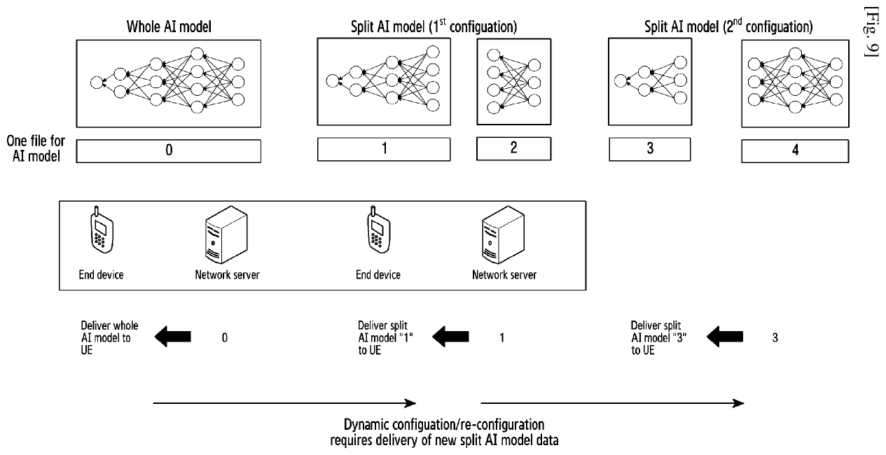

FIG. 9 shows the case where separate partial AI models, or files, are created and delivered to the UE from the network. For each arbitrary split configuration, a separate, new partial AI model file needs to be created in the network. On a reconfiguration of the split configuration (e.g. from one configuration to the another configuration), a new partial model file should be delivered from the network to the UE.

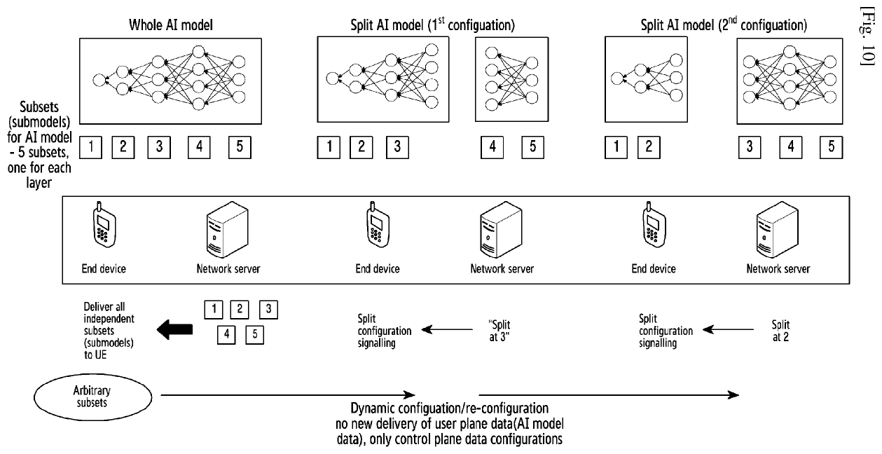

FIG. 10 shows the case where arbitrary subsets are created in the network, of the whole AI model. Subsets are independent partial AI model files, containing both AI model data as well as subset related metadata. On receipt, each subset can be inferenced independent of any other subset. The example of arbitrary subsets shown in FIG. 10 are split according to the layers of the AI model (e.g. an AI model with a total of 5 layers, split into 5 subsets, according to each layer).

At the beginning of the service, all subsets are sent from the network to the UE, and additional configuration metadata or control signalling is sent in order to indicate to the UE where the split should take place for the given configuration (e.g. which subsets the UE should use and perform split inferencing). On dynamic configuration or reconfiguration, no new delivery of AI model data (subsets) is required, since the UE has already received all independent subsets. Only control plane data configuration signalling or metadata is required.

FIG. 11 shows the case where separate partial AI models, or files, are created according to the split points previously defined for the service. The subsets are created such that no new user plane (AI mode) data needs to be delivered to the UE on reselection and configuration of a new split point, and such that no redundant subsets are created (e.g. 1, 2 in FIG. 11 need not be separate subsets if the only split configurations possible are the 2 configurations shown). Subsets are independent partial AI model files, containing both AI model data as well as subset related metadata. On receipt, each subset can be inferenced independent of any other subset. The example of arbitrary subsets shown in FIG. 11 are created in a manner such that there is no re-dundancy in the number of subsets created, as they are matched to the previously defined split point configurations for the service.

FIG. 12 is an embodiment of this disclosure showing a procedure for the delivery of an AI model with configurations between the network and UE. According to the embodiment of the FIG. 12, the AI model can be delivered in a manner described by FIGS. 9, 10 and 11.

In FIG. 12:

In step 1: Service provisioning and announcement of AI media service are performed, in particular between the 5GAI AF (application function) and the 5GAI application provider.

In step 2: Service access information acquisition is performed between 5GAI-Aware application and 5GAI application provider. That is, 5GAI-Aware application acquires service access information from 5GAI application provider. In detail:
Required AI model for the service is known in service access information (AI model known)
During this step, the available or required AI model(s) for the service can be made known to the UE, by means of information made available via a URL link pointing to a file or manifest which may last such available AI models
The received information may already contain AI model specific information, such as: the size of the AI model network, including the number of layers contained in the AI model structure, the number of nodes and links in each layer, the complexity of each layer in the AI model (i.e. the number of free parameters), the possible split points for the model for split inferencing, and also the AI model target inference delay.
Additional steps can be performed, for example model request/subscribe, building/ ingesting adapted model if not available, model selection.

In step 3: AI data session handler and 5GAI AF discovery cloud/edge and client AI media inferencing capabilities and functions.

In step 4: AI data session handler and 5GAI AF request AI split inference from each other.

In step 5: AI data session handler and 5GAI AF negotiates splitting of the AI media inference process.
A split point may be decided during this stage, and the requirements for such a split point decision maybe that such as the total AI model target inference delay (or latency) for the service. In order to decide a split point, data received from steps 2, 3, 4 and 5 may be used for various calculations on deciding a split point, either in the UE or in the network, or both.
Once a split point is decided, the configuration for the delivery of the split AI model may occur during this step, or, alternatively, it may occur when configuring the delivery pipelines for step 10. As embodiments of this disclosure, such configurations may include:
   Configuration: static_split or dynamic_split; Whether the split configuration is static during the service, or may be changed dynamically depending on factors in/ during the service.
   If dynamic_split, subset_models_flag (indicates availability of subsets); If the split configuration is assigned to be dynamic, the structure of the split AI models may be either be that shown in FIG. 9, or FIG. 10, or FIG. 11. In the case where the split AI model is divided into independent subsets as in FIGS. 10 and 11, indication that a subset structure is used may be given, using parameters such as a flag, or similar.
   For dynamic split configuration, AF sends AI model split point metadata to Data Session Handler; Additional metadata related to the split configurations and split points may be sent to the Data Session Handler (in addition to those in steps 2 or 3). Such metadata may include:
      Subset related metadata: the number of subsets, subset index for each subset, input and output layer number/index for each subset, the number of, and types of operators in each subset, input/output tensor indexes of each independent subset.
      Split point related metadata (based on subsets): the subset indexes related to each split point (e.g. network split endpoint last output subset and UE split endpoint first input subset).

In step 6: 5GAI AF acknowledges split and provides the AI data split inferencing access information to AI data session handler.

In step 7: AI data session handler acknowledges the split to 5GAI-aware application.

In step 8: 5GAI-aware application requests the start of AI data/media delivery to 5GAI client.

In step 9: 5GAI client requests to 5G AI AS, starting of AI data delivery.

After the above identified steps, split AI data session is managed between the AI model delivery related entities.

FIG. 13 shows an extension of the procedures shown in FIG. 12. FIG. 13 shows the update of the split configuration and model delivery pipelines in step 19.

In particular:

In step 10: Configuration of the AI model delivery pipelines may include the same parameters, procedures and configurations as described in step 5 under FIG. 12. AI model delivery pipelines may deliver the AI model either as:
Legacy UE split part of the AI model only (as in FIG. 9)
UE split part of the AI model as subsets
The whole AI model as subsets (as in FIG. 10 or 11)

The above delivery configurations related to that of the static/split configurations as described in step 5 under FIG. 12.

In step 11: UE AI inference runtime is created and initialized between 5G AI client and AI data handler.

In step 12: Network AI inference runtime is created and initialized between 5GAI AF and 5GAI AS.

In step 13: 5GMS delivery pipelines or other defined data pipelines are configured between related network entities.

In step 14: Split inference is processed between the UE and the network.

In step 15: AI data session handler reports UE AI status to 5GAI AF.

In step 16: 5GAI AS reports network AI status to 5GAI AF.

In step 17: 5GAI AF reports network status and network AI status to AI data session handler.

In step 18: AI data handler reports media status to AI data session handler.

In step 19, an update of the split configuration (e.g. changing the split point for split inferencing) may occur. The control signalling of this split point re-configuration (or dynamic configuration) may utilize the metadata as described in step 5 under FIG. 12. For the case where subset structures are used for delivery, on split point reconfiguration, or dynamic split point configuration, does not require any additional delivery of AI model data, if the whole model is delivered to the UE as subsets, at the beginning of the service. However, since a new split point may result in intermediate data with different characteristics, delivery pipelines for corresponding intermediate (step 13 in FIGS. 12 and 13) may need to be updated accordingly.

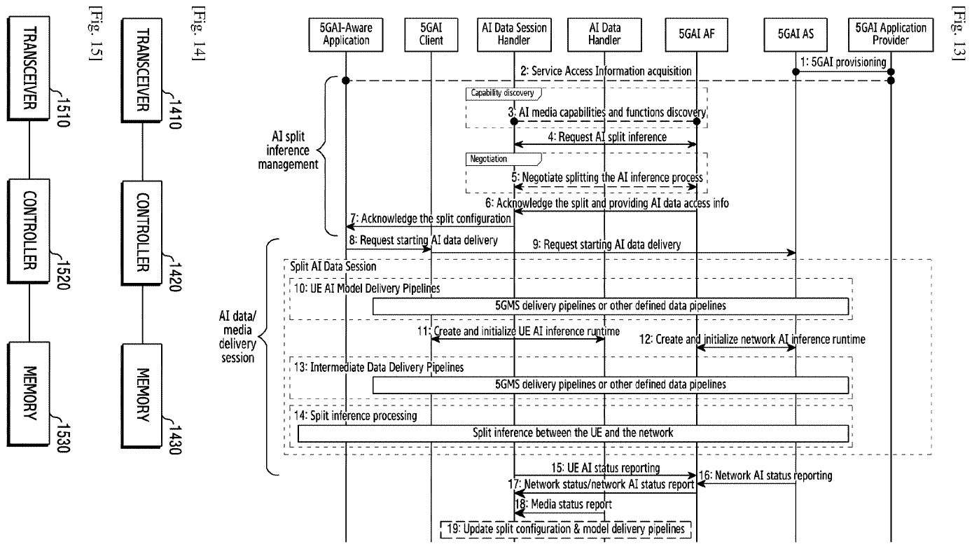

FIG. 14 is a block diagram of a terminal according to an embodiment of the disclosure.

Referring to FIG. 14, a terminal includes a transceiver 1410, a controller 1420 and a memory 1430. The controller 1420 may refer to a circuitry, or an application-specific integrated circuit (ASIC), and may include at least one processor. The transceiver 1410, the controller 1420 and the memory 1430 are configured to perform the operations of the terminal illustrated in the FIGS. 1 to 13, or described above. Although the transceiver 1410, the controller 1420 and the memory 1430 are shown as separate entities, they may be realized as a single entity like a single chip. Or, the transceiver 1410, the controller 1420 and the memory 1430 may be electrically connected to or coupled with each other.

The transceiver 1410 may transmit and receive signals to and from other network entities (e.g., a base station or another terminal).

The controller 1420 may control the terminal to perform functions according to one of the embodiments described above.

In an embodiment, the operations of the terminal may be implemented using the memory 1430 storing corresponding program codes. Specifically, the terminal may be equipped with the memory 1430 to store program codes implementing desired operations. To perform the desired operations, the controller 1420 may read and execute the program codes stored in the memory 1430 by using a processor or a central processing unit (CPU).

FIG. 15 is a block diagram of a base station according to an embodiment of the disclosure.

Referring to FIG. 15, a base station includes a transceiver 1510, a controller 1520 and a memory 1530. The controller 1520 may refer to a circuitry, or an application-specific integrated circuit (ASIC), and may include at least one processor. The transceiver 1510, the controller 1520 and the memory 1530 are configured to perform the operations of the base station illustrated in the FIGS. 1 to 13, or described above. Although the transceiver 1510, the controller 1520 and the memory 1530 are shown as separate entities, they may be realized as a single entity like a single chip. Or, the transceiver 1510, the controller 1520 and the memory 1530 may be electrically connected to or coupled with each other.

The transceiver 1510 may transmit and receive signals to and from other network entities (e.g., a terminal, a network entity, or a server).

The controller 1520 may control the base station to perform functions according to one of the embodiments described above.

In an embodiment, the operations of the base station may be implemented using the memory 1530 storing corresponding program codes. Specifically, the base station may be equipped with the memory 1530 to store program codes implementing desired operations. To perform the desired operations, the controller 1520 may read and execute the program codes stored in the memory 1530 by using a processor or a central processing unit (CPU).

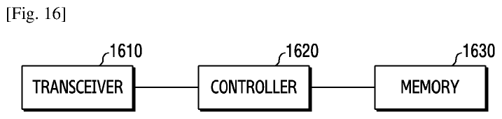

FIG. 16 is a block diagram of a network entity (or, a server) according to an embodiment of the disclosure.

Referring to FIG. 16, a network entity (or, a server) includes a transceiver 1610, a controller 1620 and a memory 1630. The controller 1620 may refer to a circuitry, or an application-specific integrated circuit (ASIC), and may include at least one processor. The transceiver 1610, the controller 1620 and the memory 1630 are configured to perform the operations of the network entity (or, server) illustrated in the FIGS. 1 to 13, or described above. Although the transceiver 1610, the controller 1620 and the memory 1630 are shown as separate entities, they may be realized as a single entity like a single chip. Or, the transceiver 1610, the controller 1620 and the memory 1630 may be electrically connected to or coupled with each other.

The transceiver 1610 may transmit and receive signals to and from other network entities (e.g., a base station, another network entity or another server).

The controller 1620 may control the network entity (or server) to perform functions according to one of the embodiments described above.

In an embodiment, the operations of the network entity (or server) may be implemented using the memory 1630 storing corresponding program codes. Specifically, the network entity (or server) may be equipped with the memory 1630 to store program codes implementing desired operations. To perform the desired operations, the controller 1620 may read and execute the program codes stored in the memory 1630 by using a processor or a central processing unit (CPU).

While the disclosure has been shown and described with reference to various embodiments thereof, it will be understood by those skilled in the art that various changes in form and details may be made therein without departing from the spirit and scope of the disclosure as defined by the appended claims and their equivalents.

As described above, embodiments disclosed in the specification and drawings are merely used to present specific examples to easily explain the contents of the disclosure and to help understanding, but are not intended to limit the scope of the disclosure. Accordingly, the scope of the disclosure should be analyzed to include all changes or modifications derived based on the technical concept of the disclosure in addition to the embodiments disclosed herein.

1. A method performed by a user equipment (UE) in a wireless communication system, the method comprising:
obtaining, from a 5G artificial intelligence (AI) application provider, service access information by a 5G AI aware application in the UE;
transmitting, to a 5G AI application function (AF) entity discovered based on an AI media capability, a request for an AI split inferencing, by an AI data session handler in the UE;
receiving, form the 5G AI AF entity, information on the AI split inferencing by the AI data session handler in the UE;
transmitting, to 5G AI application server (AS) entity, a request for starting AI data delivery based on the AI split inferencing; and
processing the AI split inferencing for data received via a data delivery pipeline between the 5G AI client in the UE and the 5G AI AS entity.

2. The method of claim 1, wherein the receiving of the information on the AI split inferencing further comprises receiving a partial AI model from the 5G AI AF entity, and wherein the processing the AI split inferencing further comprises processing the data by applying the partial AI model.

3. The method of claim 1, wherein the service access information includes at least one of information on a required AI model, or information on an available AI model.

4. The method of claim 3, wherein the service access information further includes at least one of a size of AI model network, a number of layers in AI model structure, a number of nodes and links per layer, a complexity of a layer in AI model, a possible split points for AI model for split inferencing, or AI model target inference delay, for an AI model.

5. The method of claim 1, wherein the information on the AI split inferencing includes configuration information on a split point for the AI split inferencing.

6. The method of claim 5, wherein the configuration information includes information indicating whether the split point is dynamic or static, information indicating an availability of subsets for the split point, information on metadata of the split point.

7. The method of claim 1, wherein the receiving of the information on the AI split inferencing further comprises:
receiving first information on a plurality of subsets for an AI model, wherein each of the plurality of subsets corresponds to a layer of the AI model; and
receiving second information indicating one of the plurality of subsets for the AI model.

8. A user equipment (UE) in a wireless communication system, the UE comprising:
a transceiver; and
a controller coupled with the transceiver and configured to:
obtain, from a 5G artificial intelligence (5GAI) application provider, service access information by a 5GAI aware application in the UE, transmit, to a 5G AI application function (AF) entity discovered based on an AI media capability, a request for an AI split inferencing, by an AI data session handler in the UE,
receive, form the 5G AI AF entity, information on the AI split inferencing by the AI data session handler in the UE,
transmit, to 5G AI application server (AS) entity, a request for starting AI data delivery based on the AI split inferencing, and
process the AI split inferencing for data received via a data delivery pipeline between the 5G AI client in the UE and the 5G AI AS entity.

9. The UE of claim 8, wherein the receiving of the information on the AI split inferencing further comprises receiving a partial AI model from the 5G AI AF entity, and
wherein the processing the AI split inferencing further comprises processing the data by applying the partial AI model.

10. The UE of claim 8, wherein the service access information includes at least one of information on a required AI model, or information on an available AI model.

11. The UE of claim 10, wherein the service access information further includes at least one of a size of AI model network, a number of layers in AI model structure, a number of nodes and links per layer, a complexity of a layer in AI model, a possible split points for AI model for split inferencing, or AI model target inference delay, for an AI model.

12. The UE of claim 8, wherein the information on the AI split inferencing includes configuration information on a split point for the AI split inferencing.

13. The UE of claim 12, wherein the configuration information includes information indicating whether the split point is dynamic or static, information indicating an availability of subsets for the split point, information on metadata of the split point.

14. The UE of claim 8, wherein the receiving of the information on the AI split inferencing further comprises:
receiving first information on a plurality of subsets for an AI model, wherein each of the plurality of subsets corresponds to a layer of the AI model; and
receiving second information indicating one of the plurality of subsets for the AI model.

15. The UE of claim 8, wherein the UE includes the 5G AI aware application and the 5G AI client, and the 5G AI client includes the AI data session handler and an AI data handler.
